(19) United States
(12) Patent Application Publication
(10) Pub. No.: US 2010/0285289 A1
(43) Pub. Date: Nov. 11, 2010

(54) FLOOR COVERING, FORMED FROM FLOOR PANELS AND METHOD FOR MANUFACTURING SUCH FLOOR PANELS

(76) Inventors: Oke Nollet, Gent (BE); Benny Schacht, Vlamertinge (BE); Peter Provoost, Jamestown, NC (US); Lode De Boe, Moorslede (BE)

Correspondence Address: BACON & THOMAS, PLLC, 625 SLATERS LANE, FOURTH FLOOR, ALEXANDRIA, VA, 22314-1176, US

(21) Appl. No.: 12/810,992

(22) PCT Filed: Dec. 16, 2008
(86) PCT No.: PCT/IB08/03498

§ 371 Date: Jun. 28, 2010

(30) Foreign Application Priority Data
Jan. 9, 2008 (BE) 2008/0018
Jul. 14, 2008 (BE) 2008/0388

(51) Int. Cl. B32B 3/10; B05D 5/06; B23P 17/04

(52) U.S. Cl. 428/211.1; 428/195.1; 427/256; 29/428

(57) ABSTRACT

Floor covering, of the type formed from floor panels having at their decorative side a layer representing a motif, wherein this layer in each case is composed at least of a background and of a print in the form of a motif, wherein the floor covering includes at least two floor panels which are manufactured with backgrounds of different color and/or tint, which effect a different final appearance at the decorative side.

This invention claims the benefit under 35 U.S.C. 119 (e) of U.S. provisional application No. 61/129,100.

This invention relates to a floor covering formed from floor panels, as well as to a method for manufacturing these floor panels.

More particularly, it relates to a floor covering of the type formed from floor panels having at their decorative side a layer representing a motif, wherein this layer preferably in each case is composed at least of a background and a print in the form of a motif provided thereon.

The invention can be applied with various kinds of floor panels, however, in the first place it relates to laminate floor panels. According to deviating possibilities, the invention may also be applied for other kinds of covered panels or laminate panels, such as in furniture panels, ceiling panels and/or wall panels.

More particularly, it will be applied for floor panels of the type wherein the motif is printed directly or indirectly on a paper layer, which in its turn is attached to a substrate. In particular, the invention is related to floor panels of the DPL type (Direct Pressure Laminate), wherein, as is known, the paper layer is connected to a substrate by means of impregnation with resin and by means of pressing, whether or not with still other layers. Floor panels of this type are known, amongst others, from WO 97/47834.

Another field of application consists of floor panels of the type wherein at least the motif, and possibly the background, are printed directly on a board-shaped substrate. By “directly”, it is meant that one does not first print separately on an intermediate medium, such as paper or the like, but that one will print on the substrate already having the shape of a board, whether or not using intermediate layers.

Classically, when producing floor panels for the same floor covering, one will start from the same background for all floor panels pertaining to this floor covering. Herein, the background is formed either by a material layer on which the motif is provided, wherein this material then determines the color and/or tint of the background, or by a background print provided on a material layer. As a consequence thereof, the number of different floor panels which can be present in such floor covering is restricted to the number of different printed motifs. In practice, this number is rather limited, which renders the variation of floor panels in the same floor covering relatively small, with the disadvantage that the possibility is relatively high that two identical floor panels in a floor covering will be installed next to each other. Having two identical floor panels lying in the immediate proximity of each other mostly is experienced as disturbing, in particular with floor panels representing a wood motif.

From the state of the art, for example, from document DE 10 2006 024 571 B3, it is known to increase the number of printed motifs by making the printing cylinders, which are used in printing, considerably wider than the underlying base to be printed, such that according to the position of this underlying base in width direction in respect to the printing cylinder, the obtained motif is determined. Such method requires precise positioning of the underlying base in respect to the printing cylinders and is only feasible when relating to a print performed directly on the substrate. This method seems complicated, difficult to control and expensive, as larger cylinders must be applied, which are not fully utilized. Moreover, in this technique it is difficult to realize a structure at the upper side of the floor panels which corresponds to the print, a so-called structure with impressions in register with the print.

EP 1 908 608 and EP 1 925 461 also describe possibilities for increasing the number of different floor panels. Herein, a printed decor layer repeating itself and a surface structure repeating itself with another frequency are combined, which results in floor panels with a large number of different combinations of surface structures and prints. However, the surface structure of a floor panel is not always visible, as its visibility depends on the angle under which the floor panel is observed. Thus, the possible variation described in these documents shall not always be observed as such. Moreover, it is difficult in this case, too, however, according to the aforementioned documents it is not excluded to realize a structure at the upper side of the floor panels which corresponds to the print, a so-called structure with impressions in register with the print. It is assumed that the compromises which will have to be made when designing such matching structure, will be so large that the structure will be able to correspond to the print in a limited manner only.

According to its first aspect, the present invention relates to an efficient technique by which a larger variation of different floor panels in the same floor covering is possible, without really necessitating the generation of a larger number of motifs. It also aims at a technique wherein, in case of the use of printing cylinders for printing the motif, the existing printing cylinders possibly may be used further and nevertheless a larger variation in different floor panels can be achieved. According to various preferred embodiments, the technique of the present invention also is able to offer a solution to one or more of the problems of the state of the art.

To this aim, the invention according to its first aspect relates to a floor covering of the type formed from floor panels having at their decorative side a layer representing a motif, wherein this layer then is composed at least of a background and of a print in the form of a motif provided thereon, characterized in that the floor covering comprises at least two floor panels which are manufactured with backgrounds of different color and/or tint, which effect a different final appearance at the decorative side. By using, in the same floor covering, floor panels with different backgrounds, apart from the use of different motifs, an additional variation possibility is effected which, by the application thereof, then also results in a larger variation of floor panels. The fact that the variation concerns at least a variation in color and/or tint renders it easily observable by the user under all circumstances.

It is clear that this always relates to floor panels wherein the backgrounds exert an influence on the final appearance, in other words, wherein the color or tint of the background is co-determining for the appearance in that this tint or color determines the brightness of the print applied on top thereof. By a background, a medium has to be understood which generates a uniform or at least quasi-uniform color and/or tint over the surface of a floor panel, wherein this medium can be formed by means of a print as well as in any other manner, such as, for example, by making use of paper of a different color.

In a preferred embodiment, the floor covering further is characterized in that it comprises at least two floor panels with backgrounds of different color and/or tint, which, however, are performed with equal prints for the motif. Herein, the advantage is created that with the same motif still visually differing floor panels can be realized. Herein, it is preferred that said “equal” prints for the motif are identical in respect to design as well as to color. The advantage therein is that the motif of the different floor panels can be realized with entirely the same print, such that switching to other printing inks or the like is redundant.

In a preferred embodiment, the floor covering further is characterized in that the backgrounds of said two floor panels originate from the same material layer, namely, a material layer varying in color and/or tint, either a material layer in which the color and/or tint of the material itself changes, or a material layer upon which a background print changing in color and/or tint is applied, or a material layer which is realized partially with and partially without a background print, or a combination of these possibilities. The technique applied therein offers the advantage that the floor panels differing from each other in respect to the background can be realized starting from the same basic structure, more particularly the same larger board, by which, after dividing such larger board into floor panels, automatically a mix of floor panels with different background is obtained.

In a preferred embodiment, the floor covering is characterized in that it comprises at least a first series of floor panels which are performed with a first background of a certain color and/or tint, wherein the floor panels of this first series differ from each other in that they have prints representing a different motif, and that it also comprises a second series of floor panels which are performed with a second background, the color and/or tint of which differs from the color and/or tint of the first background, but wherein this second series is performed with a motif print equal to that of the first series.

Still more particularly, it is preferred that the floor covering consists of different floor panels obtained by combining a series of at least three backgrounds differing in color and/or tint with a series of at least three different motifs.

It is clear that due to this major variations are possible and the possibility that two identical floor panels will come to lie next to each other is considerably reduced.

The invention is particularly important for floor panels of which said motifs represent a wood motif and more particularly depict one plank per floor panel. With real wood, namely no single plank is identical to the other, and thus it is important that, when imitating wood, the possibility that two identical motifs are present next to each other must be reduced, to which the invention thus clearly does contribute.

The floor panels with different backgrounds present in the floor covering preferably are of a similar type in respect to shape and in respect to the globally represented motif. By a similar type in respect to shape, it is meant, for example, that the floor panels of different background all are plank-shaped, whether or not having the same size, and thus, for example, it is not so that one floor panel is made as a plank, whereas the other is made as a tile. By a similar type in respect to the “globally represented motif”, it is meant that the floor panels with different background, for example, in case of imitating wood, represent the same wood species, for example “light oak”, “dark oak”, “merbau” etc. In fact, the use of the different backgrounds substantially is intended for creating a large number of variations in the same kind of imitation.

The print of the motif may be, amongst others, of the type which is performed by means of one or more printing cylinders. The backgrounds, too, may be of the type which is realized at least partially by means of a print by means of one or more printing cylinders. Up to date, prints by means of printing cylinders still are the most effective for performing a print. The present invention offers the advantage that it is easy to integrate into printing processes by means of printing cylinders.

With the same objective as in the first aspect, the invention, according to a second independent aspect, also relates to a floor covering of the type formed of floor panels having at their decorative side a layer representing a motif, wherein this layer in each case is composed at least of a print in the form of a motif and a colored, however, translucent layer, with the characteristic that the floor covering comprises at least two floor panels manufactured with translucent layers of different color and/or tint, which effect a different final appearance at the decorative side.

It is clear that by means of a colored translucent layer provided over the motif, similar effects can be obtained as with a background situated underneath the motif, and that therefore the variation in color and/or tint of the translucent layer according to this second aspect may offer similar advantages as the variation of the background according to said first aspect.

Such colored translucent layer may be obtained, for example, by applying a printed or colored material sheet, which possibly is provided with synthetic material. As such, it is known, for example, from WO 2004/108436, in floor panels of the DPL type to provide a protective wear-resistant layer or overlay above the paper layer with the motif. Such wear-resistant layer substantially consists of a material sheet, such as a paper layer, which is provided with synthetic material and, after being pressed, becomes translucent. From the same document, it is also known already to colorize such overlay, in such a manner that this overlay co-determines the final appearance of the decorative side of the floor panels concerned. According to the present invention, a similar technique or a printing technique is applied, wherein, however, for floor panels of the same floor covering the color and/or the tint of the translucent layer is varied.

It is noted that coloring such translucent layer may be performed by coloring or printing the material sheet, as well as by coloring or printing the synthetic material, whether or not already provided on the material sheet. Preferably, for the synthetic material an amino resin, such as melamine formaldehyde resin, is applied, which preferably is provided in liquid form on the material sheet concerned. A simple coloration is created when a pigment is mixed into the synthetic material or resin still to be applied. By such coloration, a substantially uniform tint can be obtained over the entire material sheet provided with synthetic material. The variation in color required according to the second aspect of the invention then is created by combining in each case a different colored layer with the same underlying printed motif.

It is clear that said colored or printed translucent layer preferably is obtained at least by dividing a larger translucent layer, which as such is colored or printed.

When for coloring the larger translucent layer or an overlay, a print is chosen, a non-uniform coloration of such translucent layer can be obtained in that, for example, different color areas are used, which, for example, in each case show a surface which is larger than or equal to the surface of the final decorative side of a floor panel. Variation in color and/or tint then, on the one hand, can be obtained by applying a variation of color and/or tints in said different color areas, and, on the other hand, can be obtained by varying the orientation and/or the position of these color areas in respect to the underlying motifs when providing them thereover.

To those skilled in the art, it is clear that the preferred embodiments of the first aspect mutatis mutandis also can be applied in this second aspect of the invention. For example, such floor covering further can be characterized in that it comprises at least a first series of floor panels which are made with a first translucent layer of a certain color and/or tint, wherein the floor panels of this first series differ from each other in that they have prints representing a different motif, and that it also comprises a second series of floor panels which are made with a second translucent layer, the color and/or tint of which differs from the color and/or tint of the first translucent layer, wherein, however, this second series is made with an equal print of motif as the first series.

It is also clear that the possible print of the translucent layer can be performed in any manner. For example, it may be of the type performed by means of one or more printing cylinders.

According to a third aspect, the invention also relates to a method for manufacturing floor panels for forming a floor covering according to the invention, with the characteristic that floor panels are formed with respectively at least two backgrounds or translucent layers differing in tint and/or color, which are composed to a set of floor panels for forming a floor covering.

It is noted that, as in fact becomes clear from the above, the term “background” must be interpreted broadly. So, for example, “different backgrounds” may be formed due to the fact that for one background, a print is applied, whereas for obtaining the other background “differing” therefrom, the print simply is omitted and the existing underlying base forms the background, irrespective of what this underlying base is consisting. The term “colored translucent layers”, too, is to be broadly interpreted in this sense.

Also, the term “print” preferably has to be understood broadly as any operation by which a color, tint, motif or the like is imparted to a surface. Preferably, this is by means of printing ink, however, also other substances, such as paints, may be applied for this purpose. Also, a print as such can be composed of several printings. So, for example, said motif may be realized in a classical manner with two to five printing cylinders.

It is clear that the floor panels for performing the invention may be provided with other additional features at will. For example, any substrate can be applied. In a practical form of embodiment, this will consist of MDF or HDF. Also, for example, such floor panel at its edges preferably will be provided with mechanical coupling parts, which allow to connect several of such panels to each other in a glueless manner, for example, as known from said WO 97/47834.

According to a preferred embodiment of the also above-mentioned method, said layer representing the motif is obtained at least by dividing a larger decorative print, wherein the method comprises at least forming this larger print, wherein, on the one hand, in a first printing step said backgrounds are printed and the hereby obtained first print pattern shows a first length, and, on the other hand, in a second printing step said prints in the form of a motif provided thereon are provided and the hereby obtained second print pattern shows a second length, which differs from said first length. By “length” in this case the length is meant over which the print pattern repeats itself, wherein this repetition occurs at least several times, for example, repeats itself at least three times and preferably repeats itself again and again. It is clear that said print patterns also have a width. This width preferably is substantially the same in both print patterns, or still better is completely equal.

By means of two prints provided one above the other, with print patterns of different length, a decorative print is created, portions of which are built up at least of a combination of the same motif with backgrounds of different colors and/or tints. Such portions can be applied for obtaining the decorative side of the floor panels according to the invention, as a consequence of which a large variation can be created in the decorative side of the thus obtained floor panels.

Due to the fact that the motif repeats itself after a certain length, it becomes possible to realize a structure in register with the motif in the decorative side of the floor panels in a relatively simple manner. Namely, such structure can be designed independently from the applied background and entirely on the basis of the motif, such that it is sufficient to provide only so many structures as there are motifs. Possibly, however, not necessarily, this number of motifs may be restricted to a number usually applied according to the state of the art, whereas by varying the background still a larger variation of different floor panels is obtained. In this respect, it is stated that the invention is not restricted to floor panels having a structure of impressions at their decorative side, and certainly not to floor panels having at their decorative side a structure of impressions corresponding to the motif.

Said larger decorative print may be performed on various possible underlying bases.

According to a first possibility, said larger decorative print is printed on a preferably flexible material layer, such as a paper layer or paper web, whereby, for example, so-called decor paper is obtained. Such printed material sheet, decor paper or a portion thereof, such as a sheet of decor paper, may be applied for manufacturing floor panels of the DPL type. In such manufacture first, for example, larger covered boards are obtained by connecting said decor paper or portion thereof by means of pressing, whether or not with still other paper layers, such as one or more protective layers or overlays, with a substrate, such as an MDF or HDF board (Medium Density Fiberboard or High Density Fiberboard). Herein, the decor paper or the respective portion may be provided with resin, such as melamine resin. Said dividing preferably occurs by dividing or sawing these larger covered boards. It is clear that the possible forming of decor paper sheets from said decor paper also forms part of said dividing.

According to a second possibility, said larger decorative print is printed directly onto a board-shaped substrate, whether or not using intermediate layers, such as primer layers. Such printed substrate then can be divided into separate floor panels or semi-finished products for manufacturing such floor panels. It is clear that this dividing then forms part of the process of dividing the larger print required according to said preferred embodiment.

According to still other possibilities, the two printing steps may be applied to separate underlying bases instead of a common underlying base, which then may be selected each separately from said two possibilities. The prints concerned may be formed first, for example, on separate underlying bases before being provided one above the other. For example, the background print can be provided on an opaque underlying base, such as on an opaque paper sheet or on a board material, whereas the motif print is provided on a translucent underlying base, such as on a translucent paper sheet, or vice versa, wherein in this last case floor panels can be obtained which also have the characteristic of said second aspect, wherein said background print then relates to the print of the translucent layer.

According to a particular preferred embodiment, said first printing step as well as said second printing step are performed by means of printing cylinders which are rolled off in printing direction, wherein the length of the print patterns concerned extends in printing direction. For example, the technique of rotary offset printing can be applied. Preferably, the length of the print patterns concerned corresponds approximately to the circumference of the printing cylinders concerned. Prior to the present invention, in printing processes for floor panels where printing cylinders were applied, only cylinders were used which realized print patterns with mutually equal lengths. To this aim, always printing cylinders were used having an equal or at least approximately equal circumference. However, the present inventors have found that by a controllable increase of the complexity of the printing process, namely by applying, contrary to the usual opinions, a mutually differing length of the print patterns, or by applying printing cylinders of different circumference, huge advantages can be obtained. These advantages are situated, for example, in the possibility of realizing a larger number of floor panels with different decorative sides, more particularly different prints, on the basis of this decorative print.

Preferably, the portion of the cylinders which is applied for printing the motif or the background of a floor panel extends substantially parallel to the axis of these cylinders. In other words, this preferably relates to so-called “transverse printing”, wherein the respective motif and/or the respective background in said decorative print extends transversely to the printing direction. Herein, preferably said first length as well as said second length substantially corresponds to the total width of the motifs of a whole, however, different number of floor panels. Herein, the difference in width may be even as small as approximately the width of the motif of only one floor panel. In such case, the number of different decorative sides in the final floor panels can be maximized, whereas the complexity of the printing process remains extremely controllable. Preferably, the first length, namely, the length of the print pattern of said background, has the smallest length. Equal backgrounds are less disturbing to the user than equal motifs. It must be noted that there, where according to the usual opinion, one would have used motif cylinders all resulting in print patterns with a length corresponding to, for example, six times the width of the floor panels, the inventors have noticed that by applying a smaller background cylinder in combination with motif cylinders of equal size, which background cylinder, for example, only results in a print pattern with a length corresponding to five times the width of the floor panels, five times more different decorative sides can be realized. Moreover, such printing process still can be performed on the same printing machine. Namely, in general for the motif cylinders the maximum diameter can be used which can be applied on the printing machine concerned and which corresponds to a whole number of floor panels, whereas for the background cylinder a smaller diameter can be used and still a better result can be achieved. It is noted that in general multiple motif cylinders will be used, as the motif preferably will be printed in multiple colors. The background, however, can be printed with only one cylinder, wherein a possible color change then is effected by adapting the applied amount of paint or ink, for example, by selecting the density of the printed points.

It is clear that, as also mentioned above, according to the method of the third aspect said background print may also serve as a print of a translucent layer provided above the motif print.

Further, it is noted that, when during the manufacture of the final floor panel use is made of a technique wherein impressions are provided in the decorative side of the floor panel by means of a press element, which impressions correspond at least partially to the motif depicted in the decorative side or which follow at least a portion of this motif, the number of different motifs or said length of the second print pattern preferably is limited in accordance with the size of the press element.

In general, said second length preferably is limited to a maximum of three meters.

The method of the present invention preferably is applied for manufacturing floor panels with backgrounds or translucent layers of different colors and prints with different motifs provided thereover, situated there beneath, respectively, wherein at least 75 percent of the number of possible combinations of backgrounds and prints provided on top thereof are realized. Still better, all possible combinations are realized.

According to a fourth aspect, the present invention aims at an efficient technique by which a larger variation of different floor panels is possible, without necessitating the development of a larger number of motifs, wherein the existing printing rollers or printing cylinders for printing the motif possibly may be applied further. To this aim, the invention relates to a method for manufacturing floor panels having at their decorative side a layer showing a print in the form of a motif, with the characteristic that said layer is obtained at least by dividing a larger print, wherein, when forming the larger print, two or more portions are formed showing a similar motif, wherein, however, the color intensity of the portions concerned or of a part of the portions concerned is implemented differently. According to the fourth aspect, the different implementation preferably is achieved in that for the portions concerned, the adjustment of the respective printing device is altered or varied, whereas indeed the same printing data and/or the same portion of the printing device, for example, the same portion of the printing cylinder, are applied.

The fourth aspect can be realized in various manners. For example, it is possible to use printing cylinders for the background print and for the motif print, which printing cylinders do not show the same or approximately the same circumference, wherein the amount of colorant or ink provided on the printing cylinders concerned is varied during the printing process. In rotary printing, such as intaglio printing, the applied colorant or ink can be varied by scraping off more or less from the colorant already provided on the cylinders. In a digital printing technique, such as inkjet printing, the deposited colorant or ink can be varied by varying the size of the ink jet or ink droplet or by varying the distance from the print head to the underlying base to be printed.

It is clear that the respective variation of the printing direction can be controlled as well as random. It may be performed gradually as well as stepwise. Preferably, the adjustment indeed is kept constant during printing of a respective portion. In the case of a cyclic, whether or not stepwise variation, preferably a frequency is applied differing from the frequency with which said uniform motifs are repeated.

Preferably, the printed layer is comprised at least of a background print and a motif print, wherein said variation preferably relates at least to a variation in the background print, wherein the color intensity of the motif print preferably is kept constant.

According to a fifth aspect, the invention also relates to an alternative technique for manufacturing floor panels, wherein according to preferred embodiments also a larger variation of different floor panels is possible. To this aim, the invention relates to a method for manufacturing floor panels comprising at their decorative side a layer representing a motif, wherein this layer in each case is composed at least of a background and a print in the form of a motif, wherein said layer representing the motif is obtained at least by dividing a larger decorative print, wherein the method comprises at least forming this larger print, wherein, one the one hand, in a first printing step said backgrounds are printed and, on the other hand, in a second printing step said prints in the form of a motif are provided, with the characteristic that for printing said backgrounds at least two printing cylinders or printing rollers are applied.

According to a first possibility of the fifth aspect, by means of said printing cylinders or printing rollers, backgrounds with at least 2 different colors are realized.

According to a second possibility of the fifth aspect, the larger print comprises at least a portion, the background print of which portion is obtained by means of only one of the aforementioned two printing cylinders or printing rollers, wherein this portion in size and shape substantially corresponds to a layer of one or more of said floor panels. It is clear that the second of said two printing cylinders then is at least indeed active for forming the background print of another portion of the background print of another portion of the larger decorative print.

According to a third possibility of the fifth aspect, the larger print comprises at least a portion, the background of which portion is obtained by means of both aforementioned printing cylinders or printing rollers, wherein this portion in size and shape substantially corresponds to a layer of one or more of said floor panels.

According to a fourth possibility of the fifth aspect, by means of said printing cylinders or printing rollers print patterns are realized with a mutually different length. Of course, the invention does not exclude working with print patterns of equal or approximately equal length.

It is clear that the above four possibilities of the fifth aspect can be combined at choice inasmuch as they are not contradictory. The fifth aspect can be applied in so-called “transverse printing” as well as in so-called “longitudinal printing”.

According to a sixth aspect, the invention also aims at an alternative technique for manufacturing floor panels or other covered panels, wherein according to preferred embodiments also a larger variation of different panels is possible.

More particularly, the invention according to its sixth aspect relates to a method for manufacturing covered panels comprising at least a basic panel and a top layer with a printed motif provided on this basic panel. Herein, this may relate, for example, to furniture panels, ceiling panels, floor panels or the like, which substantially consist of a MDF or HDF (Medium or High Density Fiberboard) basic panel and a top layer provided thereon, such as a laminate top layer.

As already mentioned, covered panels or floor panels of the above-mentioned type are known as such. Herein, the printed motif, whether or not by the intermediary of primer layers, can be printed directly on the basic panel or on a substrate or basic board comprising this basic panel. However, initially the print may also be provided on a flexible material sheet, such as a paper sheet, wherein this printed material sheet then as such, as a so-called decor layer, is taken up into said top layer of the covered panel or floor panel. Further, it is known that such panels can be provided with a transparent or translucent synthetic material layer, which forms a protective layer above the printed motif and may comprise, for example, wear-resistant particles, such as aluminum oxide. It is not excluded that this protective layer also comprises a material sheet, such as a paper sheet.

In the case of a laminate floor panel, manufacture may be performed, for example, according to a DPL (Direct Pressure Laminate) or HPL (High Pressure Laminate) technique. In the case of a DPL technique, one or more material sheets provided with resin, amongst which a printed material sheet forming a decor layer, are brought together with the basic panel or with a larger basic board into a press device, where, by means of a press element and under the influence of increased pressure and temperature, they are connected to each other as well as to the basic board. In the case of a HPL technique, the top layer is formed separately on the basis of two or more material sheets provided with resin, amongst which a printed material sheet forming a decor layer, before the thus obtained top layer is provided on the basic board, for example, by gluing it onto the basic board.

It is known that the printed motifs of such covered panels can be obtained by means of a method which comprises at least the steps of forming, by means of printing cylinders on a substrate, either on a flexible material sheet, or directly on a board-shaped substrate, a larger decorative print and of forming said covered panels by means of at least a portion of this substrate and the decorative print provided thereon. Herein, for the step of forming the decorative print, this relates in particular to the technique of rotary offset printing or rotary intaglio printing, which, for printing on board-shaped substrates, is known, for example, from U.S. Pat. No. 3,173,804 and EP 1 862 304, and for printing on flexible material sheets is known, for example, from EP 1 541 373. In these known techniques, the length of a print pattern obtained by means of printing cylinders is limited by the circumference of the printing cylinder. This means that, when one wants to realize covered panels with a printed motif that is longer than the circumference of such printing cylinder, this printed motif will show a repetition of at least a portion of the respective print pattern. It is noted that the length of such print pattern usually is smaller than 1.4 meters. For the step of forming the covered panels, a variety of techniques can be applied, such as, for example, a DPL technique, wherein the decorative print printed on a flexible substrate is used as a decor layer and is pressed on a larger basic board. The obtained pressed whole then is divided into smaller panels having approximately the dimensions of the final covered panels, such as floor panels.

In order to remedy the disadvantages of the offset printing technique, it is suggested, amongst others, in WO 2007/076853, to print transversely. This means that the printed motifs of the covered panels are obtained from a larger print in which these printed motifs extend transversely instead of parallel to the printing direction. In this manner, printed motifs can be realized with a length approximately corresponding to the width of the printing cylinders, without repetitions occurring in this printed motif. The width of the printing cylinders usually is larger than their circumference and may be, for example, approximately 2 meters. By this method, it is impossible to obtain printed motifs which are longer than the length of the printing cylinders, and this independently of the fact whether one wants to accept repetitions of the printed pattern or not. Moreover, due to this circumference-width-ratio of the printing cylinders in transverse printing, the number of possibly obtainable covered panels with different motif is smaller than with the usual longitudinal printing, wherein the printed motifs extend in the larger print parallel to the printing direction.

It is noted that a possible utilization of printing cylinders with a larger diameter and circumference for realizing longer print patterns of course is limited by the construction of the printing device concerned.

According to the state of the art, it is indeed possible to form larger printed motifs without repetitions by means of digital printing techniques, such as inkjet printing. However, these techniques are less fast and thus less economic than a technique in which printing cylinders are applied, such as it is the case with the technique of rotary offset printing or rotary intaglio printing, performed on a flexible material sheet or directly on a board-shaped substrate, whether or not with the utilization of intermediate layers previously provided on this board-shaped substrate.

According to its sixth aspect, the present invention offers various possibilities for eliminating one or more limitations of the state of the art. To this aim, the invention relates to a method for manufacturing floor panels comprising at their decorative side a layer representing a motif, wherein this layer in each case is composed at least of a background and a print in the form of a motif, wherein said layer representing the motif is obtained at least by dividing a larger decorative print, wherein the method comprises at least forming this larger print by means of one or more printing cylinders or printing rollers, with the characteristic that the print pattern of the larger print extends in the printing direction without repetitions over a distance which is larger than the circumference of the largest of said printing cylinders. By this, it is meant that over the respective distance there are no two print portions extending over the width of the larger print in which both the background and the motif are identical in respect to color, tint and pattern. The sixth aspect can be performed in various possible manners.

According to a first possibility of the sixth aspect, use can be made of printing cylinders with different diameter or circumference, which then also each as such lead to print patterns of different length and wherein the composition of these print patterns corresponds to the lowest common multiple of these different lengths. For a practical example, reference is made to the detailed description. Of course, the respective lengths then must be selected such that their lowest common multiple is larger than each of them. Such possibility may make use of the invention according to its third aspect.

According to a second possibility of the sixth aspect, use can be made of one or more printing cylinders showing a certain slippage in respect to the underlying base to be printed, such that the length of their respective print patterns is larger than their circumference. Preferably, such slippage is applied in one or more of the printing cylinders performing a background print. According to still another example, the technique of the fourth aspect is applied, wherein the variation of the adjustment of the printing device determines the length of the print pattern.

It is noted that a controlled application of slippage to at least one of the printing cylinders of a rotary printing press as such forms an independent inventive aspect of the present invention. Herein, this may relate to a printing press for printing on a flexible material sheet, such as a paper sheet, as well as to a printing press for printing on a solid underlying base, such as a MDF or HDF board. Preferably, such slippage is applied in a printing cylinder realizing uniform or approximately uniform color areas, as it may be the case with a cylinder for a background print.

A third possibility of this sixth aspect will be evident from the discussed below seventh independent aspect of the present invention.

According to its seventh aspect, the present invention aims at an alternative method for manufacturing covered panels, which method, according to preferred embodiments thereof, offers advantages in respect to the printing techniques known from the state of the art. So, for example, it aims at a method which allows realizing in a smooth manner printed motifs in longitudinal printing which are longer than the cylinder circumference and still do not show any repetitions in the print pattern, and allows, in longitudinal printing as well as in transverse printing, increasing the number of possibly obtainable covered panels with a different printed motif. To this aim, the invention relates to a method for manufacturing covered panels, wherein these covered panels comprise at least a basic panel and a top layer provided on this basic panel having a printed motif, wherein the method comprises at least the steps of forming a decorative print on a substrate by means of at least two printing cylinders and forming said covered panel by means of at least a portion of this substrate, with the characteristic that said decorative print is composed at least of a first print pattern and a second print pattern provided at least by means of a first and a second of said two printing cylinders, respectively, and that the decorative print is formed such that it has at least a zone in which said first print pattern is absent, whereas said second print pattern in its turn is present in the zone concerned. It is clear that the printed motif of at least one of said covered panels is formed by means of at least a portion of the zone concerned. By realizing zones in which one of the print patterns remains absent, a larger variety in the larger print is obtained, which then also results in a larger variety of covered panels with printed motifs.

It is clear that according to the seventh aspect, this preferably relates to first, second and/or further print patterns showing different motifs.

It is also clear that, the more printing cylinders and print patterns according to the invention are applied, the larger said variety can be. However, a considerable improvement is already achieved with two print patterns. Of course, it is preferred that the print patterns concerned are performed in color and that to this aim, these print patterns as such in each case preferably are realized with at least three printing cylinders, respectively, wherein each printing cylinder is responsible for a color present in the print pattern. According to a particular embodiment thereof, the step of printing may be performed by means of a printing device with six printing cylinders or more.

The above-mentioned larger variety of covered panels may manifest itself, for example, in that the technique of the invention allows forming more covered panels with a different printed motif from the same larger print, and/or in that this technique allows forming longer covered panels without any repetition of a portion of the print pattern occurring in the decor of these covered panels.

Preferably, the decorative print is formed such that it comprises at least a zone in which said second print pattern is absent, whereas said first print pattern in its turn is present in the zone concerned. It is clear that in this case the printed motif of at least one of said covered panels is formed by means of at least a portion of the zone concerned. It is clear that by means of this embodiment, a still larger variety is obtained. According to a preferred embodiment thereof, the zone in which the first print pattern is absent connects, whether or not by means of a transition portion, to a zone in which the second print pattern is absent. By omitting a second print pattern to the advantage of a first print pattern and vice versa, any repetition of the print pattern can be avoided in a smooth manner.

The above-mentioned transition portion may relate, for example, to a zone in which the print patterns concerned are made overlapping or complementary. By “complementary”, it is meant that they both determine the final appearance of the larger decorative print in this transition portion, without necessarily being provided one above the other.

According to a first important preferred embodiment of the seventh aspect, the zone in which the first print pattern is absent is made seamless in respect to an adjacent zone of the decorative print in which this first print pattern indeed is present. The seamless transition between the zones concerned leads to an invisible or at least hardly visible transition among both print patterns, such that printed motifs for covered panels can be obtained from the decorative print, which motifs comprise portions of both print patterns without rendering the transition concerned too obvious. Herein, preferably at least the pattern of said larger print is made uninterruptedly at least at the height of the transition. Herein, this may relate, for example, to a pattern of wood nerves and/or wood pores extending uninterruptedly over said transition.

According to a second important preferred embodiment of the seventh aspect, the step of forming the covered panels comprises at least a partial step in which the larger print is divided by means of cutting lines, and during the preceding step of forming the larger print, the transition between the first and the second print pattern is provided there, where such cutting line is to be provided. Such transition needs not necessarily be invisible, and in this transition, the pattern of the larger print does not necessarily have to be uninterrupted, as according to this preferred embodiment the transition concerned does not form part of a printed motif of a covered panel. According to this embodiment, it is possible to obtain covered panels or floor panels with usual dimensions, namely with a length approximately corresponding to the circumference of the applied printing cylinder, which nevertheless have a larger variety, as the second print pattern may comprise other printed motifs than the first print pattern.

Preferably, said two printing cylinders are rolled off in printing direction at least over a portion of their mantle surface, whether or not directly, over the substrate, wherein the length of the print patterns concerned extends in printing direction. Herein, this may relate to so-called transverse printing as well as to so-called longitudinal printing. In case of an indirect print, the print image of the printing cylinders concerned, for example, first may be transferred to a transfer element, preferably a transfer element with the shape of a roller or a cylinder, such as a rubber blanket cylinder, wherein this transfer element, whether or not by means of further transfer elements, forms the final respective portion of the print on the substrate. The use of somewhat compressible transfer elements, such as one or more rubber blanket cylinders, which form the final respective portion of the print on the substrate, has the advantage that the risk that with a certain degree of unevenness in the substrate an interruption in the print will occur is minimized.

Preferably, for forming said zone in which the first print pattern is absent, the printing cylinder concerned is moved away from the substrate, or vice versa. It is also possible, whether or not in combination with the above, to provide the printing cylinder concerned with an active printing surface which is smaller than its mantle surface. Such printing cylinders can be moved away from the substrate in a smooth manner. The fact that they do not or hardly print over a certain rotation angle, gives the device intended for this purpose the time to move this cylinder away from the substrate or vice versa, without having to slow it down completely. Preferably, the active printing surface is at least one half of the mantle surface, and still better at least 75% thereof. For moving away the substrate, devices intended for this purpose may be provided in the printing device. For example, one may work, certainly in case of a flexible substrate, with asymmetric impression cylinders, which reduce the pressure when the non-active printing surface of the printing cylinder concerned is being directed towards the substrate. Such asymmetric impression cylinders are known as such for other printing applications, for example, from EP 1 935 642.

It is clear that according to the seventh aspect of the invention preferably the technique of the so-called rotary offset printing is applied for printing on the substrate. Other techniques, such as intaglio printing by means of cylinders, are not excluded.

In respect to all aspects, it is noted that for the printing cylinders, cylinders can be applied wherein a printing plate is provided on the circumference of these cylinders, wherein this printing plate then shows a print image. Such printing cylinders are also called plate cylinders. Another possibility is providing the mantle surface of the cylinder itself with a print image. For an example of print images provided on the mantle surface of cylinders, reference is made to U.S. Pat. No. 6,565,761 and U.S. Pat. No. 3,759,800, wherein from this latter document it is also known as such to perform such print images in a seamless manner, which means that the mantle surface of such cylinders does not show seams in the print image.

Further, it is noted that according to all aspects, as aforementioned, such printing cylinders possibly first can form an image on a transfer element, for example, on a rubber blanket cylinder, which then, whether or not by means of further transfers, provides the image on the substrate concerned. According to the seventh aspect, in such case, it is of course at least the last transfer element, such as the rubber blanket cylinder, which is moved away from the substrate in order to interrupt the print concerned, or which is rolled on this substrate for forming the print pattern concerned.

Preferably, according to all aspects, for printing the substrate a printing device is applied comprising at least four printing cylinders, wherein according to the seventh aspect, as aforementioned, at least one of these four printing cylinders realizes a discontinuous print pattern on the substrate. According to a particular embodiment, as aforementioned, a printing device is used which comprises at least 6 printing cylinders. To with, such printing device allows applying at least three colors for the first as well as for the second print pattern, wherein each cylinder then is responsible for performing one of these two print patterns in one of these three colors. Printing presses with six cylinders are available for certain applications at specialized printing firms.

According to the seventh aspect, in the case of oblong covered panels or floor panels, the portion of both printing cylinders which is applied for printing the motif of these panels preferably extends transversely to the axis of these printing cylinders, such that the motif concerned in said decorative print extends substantially parallel to the printing direction, i.e. performing “longitudinal printing”. According to this preferred embodiment of the invention, it is obtained that the maximum obtainable length of a printed motif is not necessarily limited by the circumference of the printing cylinders or the width of the printing cylinders. Corresponding to the number of different print patterns and printing cylinders applied according to the invention for forming the decorative print, the maximum obtainable length can be chosen freely. However, already a considerable improvement in respect to the state of the art is achieved when employing two different print patterns. It is clear that according to this preferred embodiment, an embodiment of said sixth aspect is obtained.

The method of the sixth and/or the seventh aspect of the invention can offer many advantages when being applied for manufacturing floor panels with a length that is larger than the length of said first print pattern or is larger than the length of said second print pattern. To with, the invention allows, for example, in the case of longitudinal printing, performing printed motifs for these floor panels without repetitions of the print pattern, which up to date has been considered impossible by those skilled in the art, unless transverse printing was used. Preferably, the floor panels have a length situated between 1.2 and 1.7 times the length of the first print pattern. When both print patterns have approximately the same length, an interesting length can be achieved by means of floor panels having 1.5 times the length of the first print pattern, as then the printed motif of two floor panels can be realized by means of three print lengths. These dimensions lead to an economic balance wherein a certain degree of repetition in the larger print is tolerated and still a considerably larger variety of printed motifs of floor panels is achieved. Herein, the printed motif of the floor panels themselves does not show any repetitions of a print pattern or portions thereof.

When the method of the seventh aspect is applied for manufacturing floor panels, the printed decor of these floor panels preferably is formed by means of at least a portion of a zone in which said first print pattern is absent, as well as by means of at least a portion of a zone in which said second print pattern is absent. To with, this embodiment also allows forming long floor panels without repetitions in the print pattern.

Preferably, the method of the invention according to all its aspects is applied for manufacturing floor panels with printed motifs representing a wood motif and more particularly depicting one plank per floor panel. Preferably, this relates to oblong rectangular floor panels with a length of more than 1.5 meters, for example, a length of 2 meters and more, and a width of 15 cm or more, for example, a width between 20 and 30 centimeters. In such panels, the wood motif, i.e. the wood nerves and the wood pores, preferably extend in the printed motif in the longitudinal direction of the floor panel. In the case of longitudinal printing, the wood motif then also extends in the print direction on the substrate concerned. Preferably, the printed motif of such floor panel comprises at least one of said transitions between the first and the second print patterns. Of course, this then preferably concerns one or more transitions, in which the motif of the larger print is performed uninterruptedly.

As also mentioned above, there are substantially two important possibilities for the substrate on which the decorative print is provided.

According to a first possibility, said substrate relates to a preferably flexible material sheet, such a paper sheet, which, for example, forms part of a wound material web, upon said larger decorative print then, preferably uninterruptedly, is provided. Such material sheet or material web or a portion thereof then can be applied as a decor layer in a laminate floor panel. To this aim, for example, the DPL technique already mentioned above can be applied. Patent documents WO91/06728 and WO 2006/074831 give examples for decor paper sheets known from the state of the art.

According to a second possibility, said substrate relates to a board-shaped substrate, on which said print is provided directly, whether or not with intermediate layers. This may relate, for example, to a wood-based board material, such as MDF or HDF (Medium Density Fiberboard or High Density Fiberboard). Directly printing on wood-based board materials as such is known, for example, from EP 1 862 304. For possible intermediate layers and preceding grinding treatments performed on the board-shaped substrate, reference is made to WO 2006/002917.

It is noted that the substrates on which the decorative print is performed preferably have a width which corresponds or approximately corresponds to the width of the applied printing cylinders, for example, a width of 1.5 to 3 meters. Of course, it is possible to install several printing cylinders in axial direction next to each other for forming the larger print. In such case, the substrate preferably has a width corresponding to the overall width of the printing cylinders installed next to each other.

Preferably, the method of the seventh aspect also comprises the step of providing a background print on the substrate concerned. Such background print preferably is a print of uniform or almost uniform color and may also be performed, however, not necessarily, by means of the rotary offset printing technique. This background print may be performed, for example, by means of only one printing cylinder, however, may also consist of a multicolor print, or as such may also be performed according to the technique of the seventh aspect of the invention by means of at least two printing cylinders. Thus, such embodiment may also show the characteristics of the aforementioned fifth aspect of the invention.

The invention further also relates to a covered panel, whether or not a floor panel, obtained by means of a method according to all aspects of the invention. Preferably, the covered panel herein relates to a covered panel which is oblong and rectangular and comprises at least a basic panel and a top layer with a printed motif provided on this basic panel, wherein the length of the floor panel is larger than 1 meter and still better is larger than 1.5 meters and wherein the printed motif is free from repetitions.

In case the invention is applied for manufacturing floor panels, this preferably relates to floor panels with which a floating floor covering can be composed. To this aim, the floor panels are provided with mechanical coupling means at least at two opposite edges, and preferably at all edges, said coupling means allowing that two of such floor panels can cooperate with each other, wherein a locking is created in a vertical direction perpendicular to the plane of the floor covering as well as in a horizontal direction in the plane of the floor covering and perpendicular to the coupled edge. Such mechanical coupling means are known as such, for example, from WO 97/47834.

Preferably, the methods according to all aspects of the present invention also comprise a step wherein the surface of the covered panels is provided with a structure, wherein this structure preferably corresponds to the printed motifs of the covered panels. In such case, a so-called structure in register with the printed motifs is obtained. Such structure can be obtained, for example, with a DPL technique by means of a press device comprising a structured press element, more particularly a press plate. According to a particular embodiment, a larger decorative print is used which shows successive zones, wherein the print pattern over these successive zones does not repeat itself over a total length which approximately corresponds to a dimension of the aforementioned press element.

With the intention of better showing the characteristics of the invention, hereafter, as an example without any limitative character, several preferred embodiments are described, with reference to the accompanying drawings, wherein:

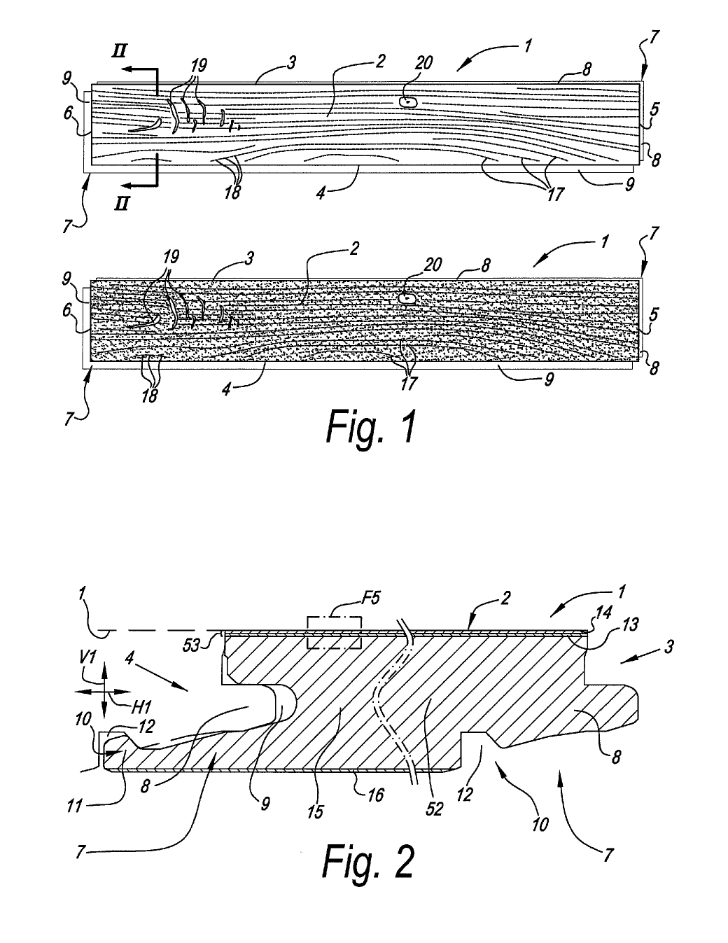

FIG. 1 represents a set of floor panels, which can be applied for forming a floor covering with the characteristics of the invention;

FIG. 2, at a larger scale, represents a cross-section according to the line II-II indicated in FIG. 1;

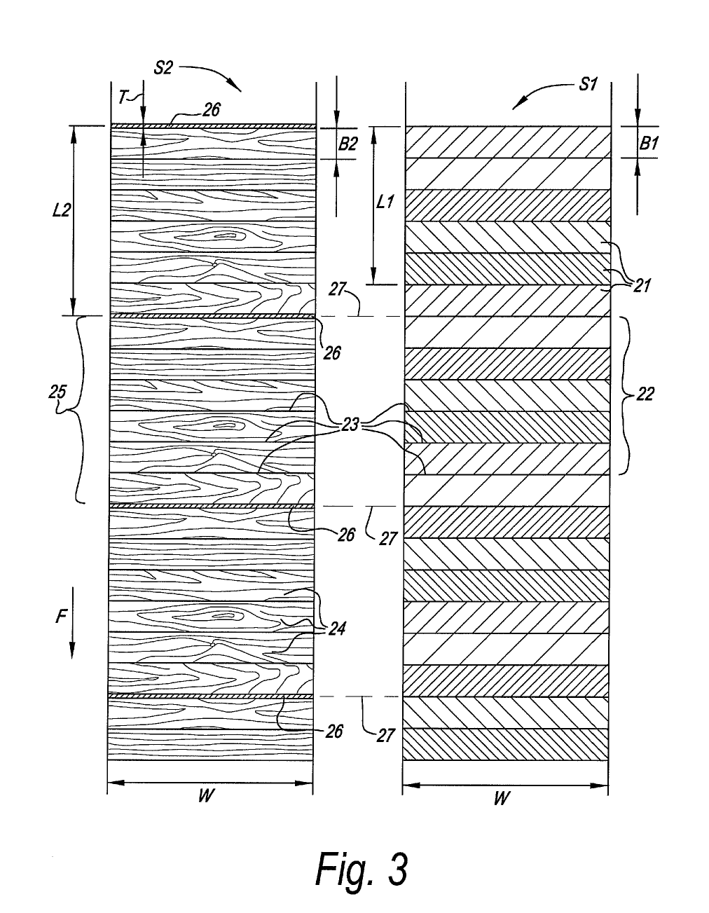

FIG. 3 schematically represents the principle of a method according to the present invention;

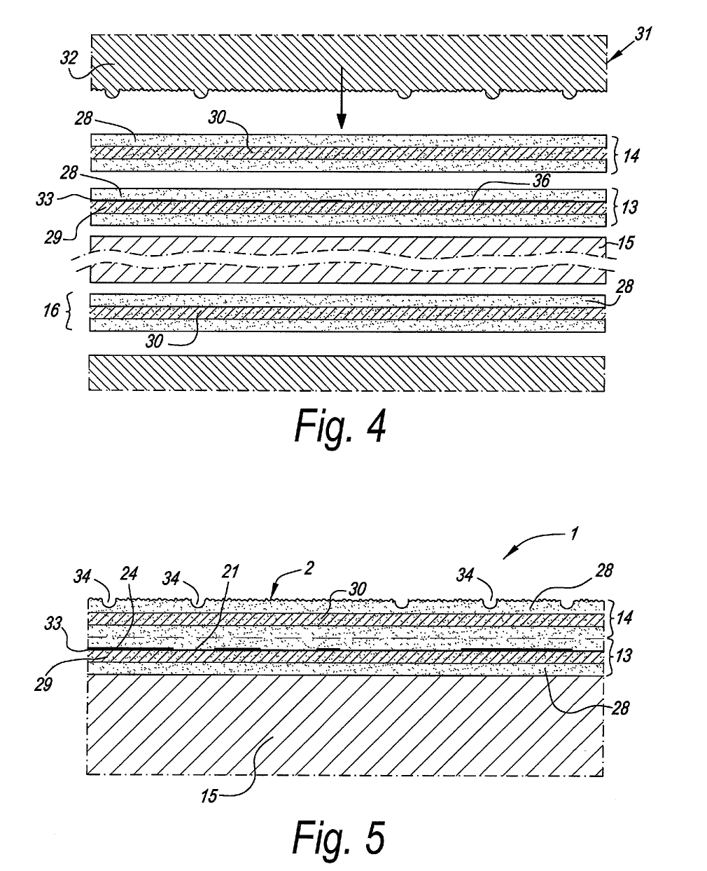

FIG. 4 represents another possible further step of a method according to the invention;

FIG. 5, at a still larger scale, represents a view on the area indicated by F5 in FIG. 2;

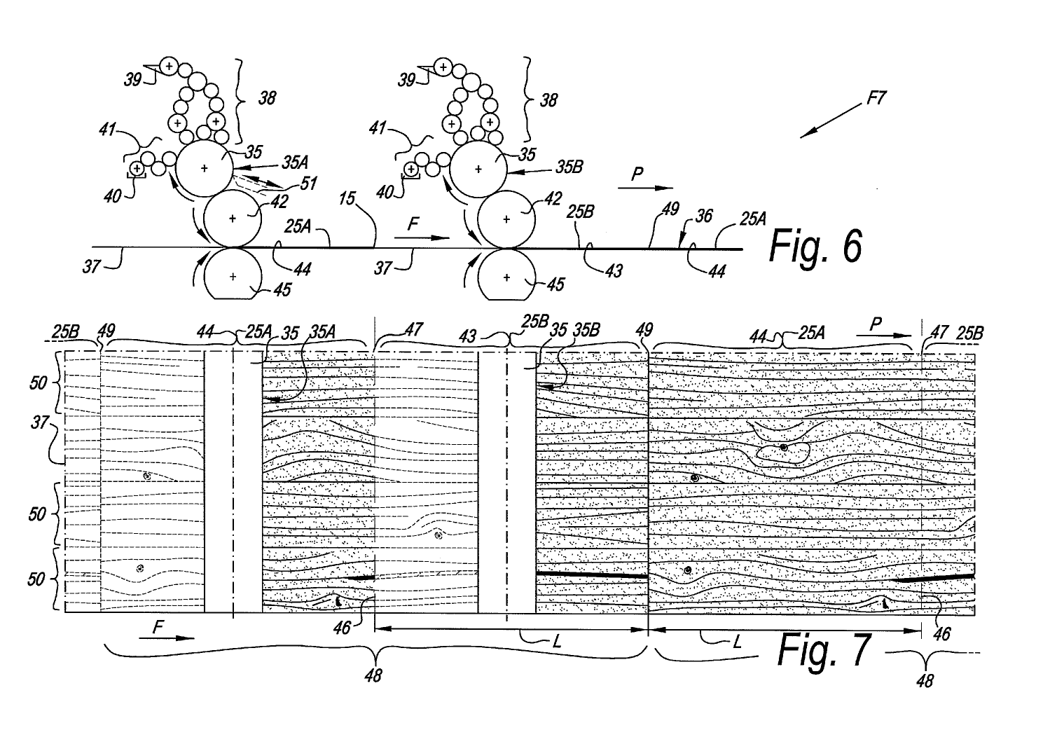

FIG. 6 schematically represents several steps in a method according to the seventh aspect of the invention;

FIG. 7 represents a view according to the arrow F7 represented in FIG. 6;

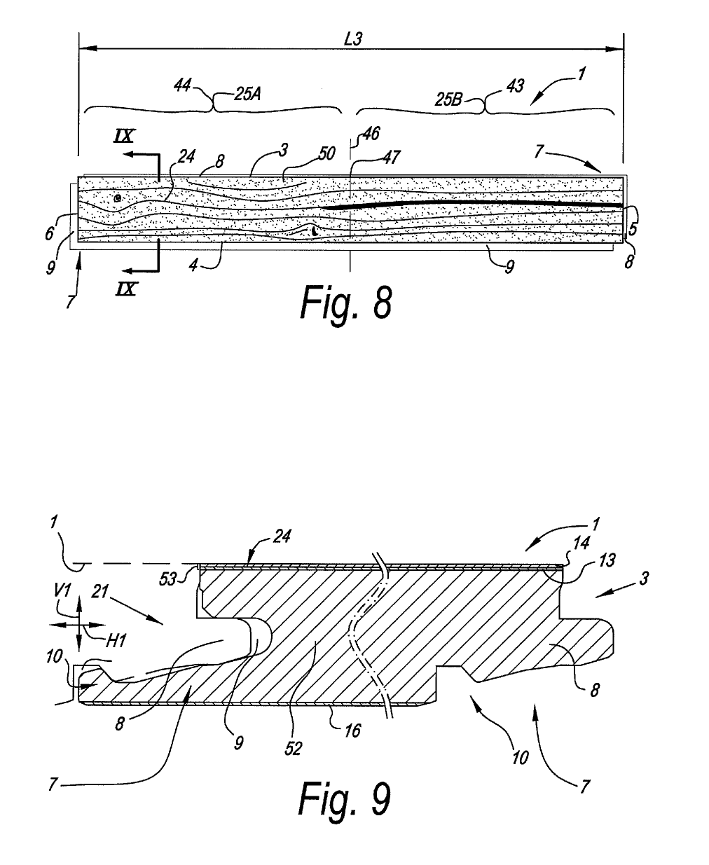

FIG. 8 represents a floor panel obtained by means of a method according to the seventh aspect of the invention; and

FIG. 9, at a larger scale, represents a cross-section according to the line IX-IX represented in FIG. 8.

FIG. 1 represents two floor panels 1 which can be applied for forming a floor covering. Here, this relates to oblong, rectangular floor panels 1 representing a wood motif at their decorative side 2 and being destined for forming a so-called floating floor covering, wherein these floor panels 1, at least at two opposite edges 3-4 and here at all opposite edges 3-4-5-6, comprise mechanical coupling means 7, which allow coupling these floor panels 1 at their edges 3-4-5-6 to each other. It is clear that the invention is not limited to floor panels 1 with decorative sides 2 representing a wood motif, but that it may be applied as well for decorative sides 2 representing another motif, such as a stone motif, a tile motif, a cork motif, a bamboo motif or a fantasy motif.

FIG. 2 represents that when coupling such floor panels 1, a locking is created in a vertical direction V1 perpendicular to the plane of the coupled floor panels 1, as well as in a horizontal direction H1 perpendicular to the respective edge 3-4 and in the plane of the coupled floor panels 1. Herein, the locking in vertical direction V1 substantially is achieved in that said mechanical coupling means 7 substantially are made as a tongue-in-groove connection 8-9. For the locking in horizontal direction H1, said tongue 8 and groove 9 also comprise locking elements 10 in the form of an upstanding portion 11 at the underside of the groove 9 and a portion 12 cooperating therewith at the underside of the tongue 8.

FIG. 2 also clearly shows that the floor panels 1 illustrated here comprise a decorative side 2 which is built up in layers, more particularly is built from a layer 13 or decor layer representing said motif, and an overlay or other protective layer 14 provided thereover, which substantially is made transparent or translucent, such that said motif remains visible. Such layered construction typically can be achieved, for example, when this floor panel 1 is manufactured by the also above-mentioned DPL technique, wherein then preferably at least said decor layer 13 comprises a printed material sheet, such as a paper sheet, which is provided with resin, such as melamine resin. Possibly, also the overlay or protective layer 14 can comprise a paper sheet provided with resin. Of course, such layered construction can also be obtained via other procedures, for example, by directly forming a print layer on the substrate 15, whether or not using intermediate layers, over which print layer then a substantially transparent or translucent protective layer 14, such as a lacquer layer, can be provided.

Although this is not represented here, the decorative side 2 can comprise hard particles, such as aluminum oxide, said particles being situated at least above the print of the layer 13 representing the motif.

FIG. 2 shows that a backing layer 16 can be provided at the underside of the floor panels 1. Such backing layer 16 may also be realized on the basis of a material sheet provided with resin.

The particularity of the floor panels 1 from FIG. 1 is that the layer 13 representing the motif is composed at least of a background and a print provided on top thereof in the form of a motif. The floor panels 1 represented here comprise backgrounds of different tints, by which a differing final appearance of the decorative side 2 of the floor panels 1 is achieved. The floor panel 1 illustrated at the top in FIG. 1 comprises a background, for example, in the form of a print, with a lighter tint than the floor panel 1 illustrated at the bottom in FIG. 1.

Although the two floor panels 1 in the example of FIG. 1 comprise backgrounds of different tints, they are performed with equal prints for the actual wood motif, which in this case are identical in respect to design as well as to color. Amongst others, the design of the wood motif concerned shows wood nerves 17, wood pores 18, wood silver grains 19 and/or wood knots 20. Moreover, the wood motif in this case represents only one wooden plank per floor panel 1.

Preferably, the invention is applied in relatively large floor panels 1. In particular with these floor panels 1, according to the state of the art a lack of variation can occur in the floor covering. Therefore, the invention preferably is applied for floor panels 1 with a decorative side 2 with a surface which is larger than 0.25 m² and still better is larger than 0.30 m². In oblong floor panels 1, preferably a length is used which is larger than 1.6 m or is approximately equal to or even larger than 2 meters. A good value for the width of such oblong floor panels 1 is 18 to 35 centimeters, or still better 21 to 25 centimeters. Of course, it is not excluded that the invention can also be applied in other, possibly smaller sizes of floor panels.

FIG. 3 schematically shows a possible principle for a method by which the floor panels 1, more particularly the respective layers 13 representing the motif, can be manufactured. In the floor panels 1 concerned, said layer 13 representing the motif is obtained at least by dividing the same larger decorative print. Such larger print can be performed on a flexible material layer, such as on a paper web, or can be printed directly on a board-shaped substrate, whether or not using intermediate layers.

When forming said larger decorative print, in a first printing step S1 said backgrounds or the background print 21 are printed. The first print pattern 22 obtained hereby is represented schematically by means of the print pattern 22 shown at the right hand side in FIG. 3, wherein the different shadings represent backgrounds 21 of different color and/or tint.

The print pattern 22 of the background print schematically illustrated in FIG. 3 has a length L1 substantially corresponding to the common width of the motifs of a whole number of floor panels 1, in this case, of five floor panels 1.

It is noted that the transitions 23 from the one color or tint to the other do not necessarily have to be sharply contoured in the print pattern 22, but, for example, also may gradually merge into each other over a certain distance. It is preferred to arrange the different backgrounds 21 in such a manner that the transitions 23 show a minimum color and/or tint difference. It is also possible that the print pattern 22 of the background print almost continuously changes its tint or color over its length L1, whereby no or almost no transitions can be observed in this print pattern 22.

Further, it is noted that the different backgrounds 21 extend transversely in respect to the longitudinal direction F of the underlying base to be printed. This may be achieved, for example, by rotary offset printing, wherein the background cylinder or background cylinders are rolled off in the longitudinal direction F of the underlying base, or wherein, in other words, the printing direction coincides or approximately coincides with the longitudinal direction F of the underlying base, for example, with the longitudinal direction F of a paper web to be printed. In such an arrangement, this relates to so-called “transverse printing”.

In a second printing step S2, which preferably immediately follows said first printing step S1 and preferably is performed on the same underlying base, said prints 24 provided over the background 21 are provided in the form of a motif, more particularly a wood motif. The print pattern 25 provided in this second printing step S2 is schematically represented by means of the print pattern 25 shown at the left hand side in FIG. 3. Here, too, the printed motifs 24 extend transverse in respect to the longitudinal direction F of the underlying base to be printed, which also can be obtained by rotary offset printing in “transverse printing”.

It is clear that the final printing result is created by the superposition of the background print 21 and the motif print 24, which is not represented here, wherein preferably the register among the possible transitions 23 concerned is respected as good as possible.

The print pattern of the motif print illustrated in FIG. 3 shows a length L2 substantially corresponding to the total width of the motifs of a whole number of floor panels 1, in this case, of six floor panels 1. Thus, the length L2 of the second print pattern 25 differs from the length L1 of the first print pattern 22 by a value approximately corresponding to the width of the motif of only one floor panel 1. When the background print 21 and the motif print 24 from FIG. 3 would be superposed, it becomes clear that such difference in length results in a maximization of the number of combinations between background print 21 and motif print 24. The specific combination of FIG. 3 results in 30 different combinations between background and motif, such that by dividing the obtained larger print, floor panels 1 can be formed with 30 different decorative sides 2.

It is clear that the background print 21 may also be absent in certain portions of the print pattern 22 concerned, whereby the respective underlying base then, for example, determines the background at this place, which then as such results in an alteration of the color and/or tint of this print pattern 22.

It is also noted that, when a print pattern 22 without transitions 23 is used for the background print 21, not necessarily a register or accordance must be maintained among the transitions 23 in the motif print 24 and the background print 21. Preferably, however, at least transitions 23 are present in the background print 21, whether or not being gradually. By transitions 23, namely stronger variations can be created, with which a noticeable “plank effect” can be obtained, which means that the final floor panels 1 show clearly distinguishable background colors. Transitions 23 in the motif print 24 are not indispensable, however, as such also lead to stronger possible variations.

Further, it is clear that the backgrounds of the floor panels 1 represented in FIG. 1, when the method of FIG. 3 is applied, may originate from the same material layer or underlying base, which varies in color and/or tint. In this case, this concerns a material layer or underlying base on which a background print 21 changing in color and/or tint is applied.

As clearly represented in the print pattern 25 of the motif print 24 of FIG. 3, so-called “technical zones” 26 may be taken into account in the print pattern 25. Those are material zones which are removed, amongst others, when dividing the larger print and thus do not form part of the motif of the decorative side 2 of the final floor panels 1. Such technical zones 26 may also be provided for other purposes, for example, for compensating possible length alterations of the printed underlying base or for applying marks which can be utilized in the further production course of the floor panels. In the example, such technical zone 26 with length T in each case is provided at the beginning of the print pattern 25 of the motif print 24. In order to prevent that the register between the motif print 24 and the background print 22 will shift, the distance B1 between successive color and/or tint alterations in the background print 22 is chosen larger than the distance B2 between the successive motif alterations in the motif print 25. Herein, the difference in size is the length T divided by the number of different motifs in the print pattern 25 of the motif print 24. This value for the difference provides for that the register between the background transitions 23 and the motif transitions 23 in each case is maintained at the beginning of the print pattern 25 of the motif print 24. In FIG. 3, this is illustrated by means of the dashed lines 27.

Such technical zone preferably has a length T situated between 0.2 and 0.6% of the length of the print pattern of the motif print. A good value for the length T is, for example, 3 to 10 millimeters.

As illustrated in FIG. 3, the motifs and backgrounds extend with their longitudinal direction over substantially the entire width W of the underlying base concerned, for example, of the paper web. It is clear that this is not necessarily so, but that also multiple or a varying number of motifs positioned next to each other can be applied. Preferably, for the motif of the decorative side 2 of a floor panel 1, substantially an entire motif from the print pattern 22-25 is applied. However, it is not excluded that a motif from the print pattern 22-25 is divided for being applied in several floor panels 1.

In the case that the underlying base of the printing process of FIG. 3 relates to a flexible material web, such as is the case when manufacturing a decor paper web for DPL floor panels 1, for the further manufacture of the floor panels 1 material sheets or decor papers can be obtained from this web, the size of which substantially corresponds to the decorative side 2 of several floor panels 1 and preferably corresponds to a whole number of lengths L2 of the print pattern 25 of the motif print 24.

FIG. 4 shows a possible further step in the manufacture of the floor panels 1 of FIG. 1. Here, this relates to manufacturing by means of a DPL technique. Herein, a decor paper 29 provided with resin 28, and an overlay 14 also comprising a paper sheet 30 provided with resin 28, are consolidated with a substrate 15 in a press device 31. At the underside of the substrate 15, by means of the same press treatment a backing layer 16 or balancing layer is provided, which layer also comprises a paper sheet 30 provided with resin 28. It is clear that the decor paper 29 concerned can be obtained from a decor paper web, which is printed by means of a method as outlined by means of FIG. 3, wherein said resin 28 is provided on this decor paper 29 while this latter still did or did not form part of said decor paper web. Thus, it is clear that the respective decor paper 29 comprises the motifs destined for multiple floor panels 1 and that therefore by means of the press treatment preferably larger covered boards are obtained, which in a further treatment are divided into panels approximately showing the dimensions of the final floor panels 1.

FIG. 4 shows that the press device 31 comprises a structured press element 32, for example, a press plate. By means of this press element 32, impressions can be formed in the decorative side 2 of the larger covered panels. Preferably, the impressions realized in this manner correspond at least to a portion of the print 33 of the decor paper 29 or follow at least a portion of this print 33. In such case, the size of the press plate 32 preferably corresponds approximately to a whole number of times the length L2 of the print pattern 25 of said motif print 24, such that each motif occurring in this print pattern 25 can be provided with corresponding impressions.

FIG. 5 shows a detail of the obtained floor panel or the larger covered board, from which becomes clear that the structured press element 32 results in impressions 34 in the decorative side 2 of the floor panel 1. Such impressions 34 preferably comprise a deepest point situated above the decor paper 29.

In the case of floor panels 1 with a wood motif, as in the floor panels 1 of FIG. 1, the impressions 34 can form imitations of the structure of wood characteristics, such as wood pores 18, wood nerves 17, wood silver grains 19 or wood knots 20, which then possibly correspond to similar wood characteristics depicted in the motif of the floor panels 1.

It is clear that there, where in the afore-going the superposing of a print in the form of a motif and a background is discussed, this does not necessarily mean that the print concerned entirely or partially covers the background. What is meant is that the background co-determines the appearance of the decorative side 2 on which the print in the form of the motif is situated. To with, it is possible that unprinted areas are situated in the background, which are intended for the print in the form of the motif, and wherein the cooperation of the background and the motif determines the final appearance of the floor panel concerned. Of course, it is not excluded that the print in the form of a motif entirely or partially covers said background.

It is clear that according to the invention the backgrounds and the motifs also can be combined at will, i.e. without a fixed sequence, or with print patterns without a fixed length. Such embodiment may be achieved, for example, when at least in one of the printing steps of FIG. 3 a digital printing technique, such as inkjet printing, is applied.

In connection with FIG. 3, it is noted that according to a deviating variant of the invention at least two motif prints can be used having a print pattern of different length, wherein not necessarily a background print or a background print with a print pattern of different length is applied. In this manner then also a broader variation in the larger print can be obtained.

According to this deviating variant, it is also possible to work with a random combination of both motif prints instead of with print patterns of fixed length. In such case, preferably at least one of the motif prints is realized by means of a digital printing technique.

FIG. 6 schematically represents a step in a method for manufacturing covered panels according to the seventh aspect of the present invention. Herein, this relates to a step in which by at least two printing cylinders 35 a decorative print 36 is formed on an underlying base or substrate 37. In the example, herein the technique of rotary offset printing is applied, wherein so-called plate cylinders are applied as printing cylinders 35, wherein the printing plate situated on the mantle surface of the cylinder 35 comprises the printing image of a print pattern 25A-25B to be applied. Said printing image is formed in that the printing plate, on the one hand, comprises water-friendly portions and, on the other hand, comprises ink-friendly portions, wherein the print pattern 25A-25B is formed by means of the ink-friendly portions. As FIG. 6 represents, ink from an ink container 39 or ductor is provided by means of ink rollers 38 on the plate cylinder or printing cylinder 35, whereas the printing cylinder 35 is wetted from another reservoir 40 by means of wetting rollers 41. During each rotation, the printing cylinder 35 first moves along the wetting rollers 41, which wet the non-printing portions, for example, with water, thereafter the printing cylinder 35 moves along the ink rollers 38, which apply ink to the water-repellent portions of the printing cylinder 35 or printing plate.

In the represented case, the ink which is provided on the printing cylinder 35 is transferred to a transfer element 42, in this case, a rubber blanket cylinder, which transfers the print pattern 25A-25B concerned onto the underlying base or substrate 37 to be printed.

It is noted that a possible drying installation for drying the formed print 36 is not represented here, however, that such drying preferably in each case is applied at least between two successive printing cylinders 35. A drying of the formed print 36 allows maintaining the register among the respective print patterns 25A-25B provided by successive printing cylinders 35 in a better manner. This latter is certainly the case when a paper sheet or another porous underlying base is used as a substrate 37. A porous underlying base namely can show considerable stretching when such underlying base takes up the ink of the print 36 at least to a certain extent.

According to the invention, said decorative print 36 is composed at least of a first print pattern 25A and a second print pattern 25B, at least provided by means of a first printing cylinder 35A and a second printing cylinder 35B, respectively, of said two printing cylinders 35. In the example, the decorative print 36 is formed such that it shows at least a zone 43 in which said first print pattern 25A is absent, as well as shows at least a zone 44 in which said second print pattern 25B is absent. In the example, this relates to print patterns 25A-25B of approximately the same length L, wherein this length is situated between 75% and 100% of the circumference of the printing cylinders 35A-35B concerned.

In the example, asymmetric impression cylinders 45 are used, which reduce the pressure when the respective printing cylinder 35A-35B or rubber blanket roller 45 is inactive. Hereby, it can be obtained that the respective printing cylinder 35A-35B or rubber blanket roller 45 is relatively moved away from the substrate 37 at the right moments.

FIG. 7 shows the aforementioned zones 43-44 of the larger print 36 in a clear manner. From this, it is clear that the zones 43 in which the first print pattern 25A is absent connect to a zone 44 in which the second print pattern 25B is absent. Moreover, the zones 43 in which the first print pattern 25A is absent are performed seamlessly with an adjacent zone 44 of the decorative print 36 in which this first print pattern 25A is present indeed. Such seamless embodiment or approximately seamless embodiment is represented in FIG. 7 with the dashed line 46. In this case, the decorative print 36 shows a wood motif extending uninterruptedly over the transition 47 of at least two zones 43-44. In this manner, a larger zone 48 with a continuous wood motif is formed, from which then, for example, long floor panels 1 can be formed. In the example, this relates to the transition 47 in printing direction P or length direction F of the underlying base, viewed from the first print pattern 25A towards the second print pattern 25B. It is evident that the transition 49 in printing direction P, viewed from the second print pattern 25B towards the first print pattern 25A, can be realized in a similar manner, however, this is not represented here. In such case, a so-called endless print 36 might be realized.

FIG. 7 relates to so-called longitudinal printing, wherein the portions 50 of the decorative print 36, which are intended for use as a printed motif of one or more floor panels 1, extend in the printing direction P. As a substrate 37, use is made of a flexible material sheet, namely, a paper sheet. Preferably, said substrate 37 or the underlying base to be printed is made as a paper web, which is taken, for example, from a paper roll and, for example, is stocked again on a roll after finishing the printing process.

In the example of FIG. 7, the larger zone 48 with a continuous wood motif extends in the printing direction P over a distance which is larger than the circumference of the largest cylinder 35 applied in the printing process. Moreover, over this distance no repetitions occur in the motif or the background. As such, FIG. 7 thus forms an illustration of a method with the characteristics of the sixth aspect of the invention.

It is shown in FIG. 6 in dashed line 51 that in rotary printing presses a scraping device can be used, which can remove a surplus of ink from the printing cylinder 35. According to the fourth aspect of the invention, the adjustment of such printing device, more particular of such scraping device, can be applied for obtaining variation in a print pattern 22-25-25A-25B. Namely, by controlling such scraper device, the color intensity of the obtained print pattern can be varied, as a result of which as such also a larger number of different floor panels on the basis of the obtained larger print 36 can be realized.

It is clear that a rotary printing device, as schematically represented in FIG. 6, can be applied in the methods according to all aspects of the invention. Instead of with rotary offset printing, for example, also intaglio printing can be used.

Further, it is clear that the print patterns 25A-25B in a method according to the seventh aspect also can be print patterns of a background print 21.

FIG. 8 represents a floor panel 1 which is obtained by means of a method with the characteristics of, amongst others, the seventh aspect of the invention. It relates to a floor panel 1 which is oblong and rectangular. At least at two opposite edges 3-4, and in this case at both pairs of opposite edges 3-4 and 5-6, the floor panel 1 is provided with coupling means 7 which allow that two of such floor panels 1 can be coupled to each other, wherein in the coupled condition at the respective edges 3-4, 5-6 a mutual locking is obtained in a vertical direction V1 perpendicular to the plane of the coupled floor panels 1, as well as in a horizontal direction H1 perpendicular to the respective edge 3-4, 5-6 and in the plane of the coupled floor panels 1. To this aim, said coupling means 7, as FIG. 9 shows, substantially are made as a tongue 8 and a groove 9, which, for the locking in horizontal direction H1, is provided with locking elements 10.

FIG. 8 also shows that the floor panel 1 is a covered panel comprising a basic panel 52 and a top layer 53 provided on this basic panel 52. The top layer 53 as such comprises a decor layer 13 and a transparent or translucent protective layer 14, such as a so-called overlay, which is provided over the decor layer 13. As is clear from FIG. 8, the decor layer 13 shows a print 24 in the form of a motif which is free from repetitions. The decor layer 13 is obtained as a portion 50 of the printed substrate 37, which is realized by means of the method of FIG. 7. Herein, the print 24 in the form of a motif shows portions of the first print pattern 25A as well as portions of the second print pattern 25B. The print 24 in the form of a motif also comprises a portion of the transition 47 between both print patterns 25A-25B. Thus, this relates to a floor panel 1 with a length L3 which is larger than the length L of each print pattern 25A-25B present in the larger decorative print 36. It is noted that the floor panel 1 of the example is of the type showing a wood motif, wherein this wood motif more particularly depicts one plank per floor panel 1.

In general, the invention according to all of its aspects preferably is applied for floor panels 1 of the type showing a wood motif, wherein this wood motif more particularly depicts one plank per floor panel 1.

When the printed substrate 37 as such relates to a web-shaped substrate 37, such as a paper web, in the first place several decor sheets can be obtained therefrom, whether or not after such web-shaped substrate 37 has been subjected to a treatment, such as a treatment by which resin is provided on the substrate 37. By means of the DPL or HPL technique, such resin-provided decor sheet, together with a possible protective layer, which also may comprise a material sheet provided with resin, is provided on a larger basic board, which covered basic board then can be divided into panels having approximately the size of the final floor panels 1. The thus obtained covered panels then can be subjected to still further treatments, such as edge treatments for forming said coupling means 7. As a basic board or basic panel, then a board, panel, respectively, on the basis of wood and/or synthetic material can be applied, such as a MDF or HDF board, panel, respectively.

It is noted that the floor panel 1 of FIG. 8 also comprises a backing layer 16 or balancing layer, which is provided at the underside of the basic panel 52. For such backing layer 16 or balancing layer, also a material sheet provided with resin, such as a paper sheet, can be applied.

When material sheets provided with resin are mentioned, then, for example, a thermo-hardening resin, such as melamine resin, can be applied as the resin.

It is clear that, although in the above text passages a first printing cylinder 35A and a second printing cylinder 35B, as well as a first print pattern 25A and a second print pattern 25B are mentioned, the invention is not limited to the specific sequence of the printing cylinders 35-35A-35B and/or print patterns 25A-25B concerned, nor to a possible direct succession of the printing cylinders 35-35A-35B and/or print patterns 25A-25B concerned. Indeed, according to the invention it is possible that one or more print patterns 25A-25B are formed on the substrate 37 by means of one or more intermediate or preceding printing steps, whether or not by means of printing cylinders, and/or that the first printing cylinder 35A is situated in printing direction after the second printing cylinder 35B.

Referring to FIGS. 2 and 9, it is also noted that the protective layer 14 provided with resin can be colored or printed, wherein this coloration or print can be varied and combined with layers 13 representing different prints 24 in the form of motifs. In this manner, a floor covering can be obtained with the characteristics of the second aspect mentioned in the introduction. For the possible printing of the protective layer, all herein above-discussed methods may be applied.

The present invention is in no way limited to the herein above-described embodiments, on the contrary may such floor covering and method be realized according to different variants, without leaving the scope of the invention.

1-40. (canceled)

41. Floor covering, comprising floor panels having a decorative side, said decorative side including a layer representing a motif, wherein the layer of each panel comprises at least a background and a print in the form of said motif provided thereon, said floor further covering comprising at least two of the floor panels which are manufactured with backgrounds of different color and/or tint, which effect a different final appearance on the panel decorative sides, and/or, while having backgrounds of different color and/or tint, are made with identical prints for the motif.

42. The floor covering of claim 41, wherein said identical prints for the motif are identical in respect to design as well as to color.

43. The floor covering of claim 41, wherein the backgrounds of said two floor panels originate from a same material layer, said material layer varying in color and/or tint, said material layer comprising a material layer in which the color and/or tint of the material itself changes, or a material layer upon which a background print changing in color and/or tint is applied, or a material layer which is performed partially with and partially without a background print, or a combination thereof.

44. The floor covering of claim 41, comprising at least a first series of floor panels which are formed with a first background of a certain color and/or tint, the floor panels of the first series differing from each other in that they have prints representing a different motif, and comprising a second series of floor panels which include a second background, the color and/or tint of said second background differing from the color and/or tint of the first background, but being provided with an identical printed motif as the first series.

45. The floor covering of claim 41, wherein the floor panel backgrounds comprise a paper layer and/or a print present on a paper layer, over which then the print is applied in the form of the motif, which paper layer in turn is attached to a substrate.

46. The floor covering of claim 45, wherein the floor panels are of the direct pressure laminate (DPL) type, wherein the paper layer is connected to the substrate by means of impregnation with resin and by means of pressing, with or without other layers.

47. The floor covering of claim 41, wherein the floor panel backgrounds comprise a print which is applied directly on a board-shaped substrate.

48. The floor covering of claim 41, wherein the panels comprise different floor panels comprising a series of panels having at least three backgrounds differing in color and/or tint with a series of at least three different motifs.

49. The floor covering of claim 41, wherein said motifs all represent a wood motif.

50. The floor covering of claim 49, wherein the motif represents one plank per panel.

51. Method for manufacturing floor panels for forming a floor covering, said panels having at their decorative side a layer representing a motif, wherein the layer of each panel comprises at least a background and of a print in the form of a motif provided thereon, comprising the steps of: forming the panels with respectively at least two backgrounds differing in tint and/or color, and assembling a set of the floor panels to form a floor covering.

52. The method of claim 51, wherein said layer representing the motif is made at least by dividing a larger decorative print, comprising at least forming the larger print, using a first printing step wherein said backgrounds are printed and the resulting first print pattern displays a first length, and, in a second printing step, said prints provided thereover are provided in the form of a motif and the resulting second print has a second length which differs from said first length and wherein said first printing step as well as said second printing step are performed by means of printing cylinders which are rolled in a printing direction, wherein the length of the respective print patterns extends in the printing direction and wherein the portion of the cylinders which is applied for printing the motif of a floor panel, extends substantially parallel to the axis of the cylinders, such that the respective motif extends transversely to the printing direction in said decorative print, and wherein said first length and said second length substantially correspond to the common width of the motifs of a whole, however differing number of, floor panels.

53. The method of claim 51, including manufacturing floor panels with backgrounds of different colors and prints applied thereover with different motifs, wherein at least 75 percent of the number of possible combinations of backgrounds and prints provided thereover are produced.

54. Method for manufacturing floor panels, which comprise at their decorative side a layer displaying a print in the form of a motif, comprising forming said layer at least by forming and dividing a larger print, wherein, when forming the larger print, two or more portions are formed showing a uniform motif, wherein the color intensity of the respective portions or of a part of the respective portions is produced differently.

55. The method of claim 54, wherein a different production is achieved by, for the respective portions, altering or varying the respective printing device, while applying the same printing data and/or the same portion of the printing device.

56. Method for manufacturing floor panels, which comprise at their decorative side a layer representing a motif, wherein the layer comprise at least a background and a print in the form of a motif, comprising the steps: said layer representing the motif is obtained at least by forming and dividing a larger decorative print, and, in a first printing step, printing said backgrounds and, in a second printing step, providing said prints in the form of a motif, wherein for printing said backgrounds, at least two printing cylinders or printing rollers are used.

57. Method for manufacturing floor panels, which comprise at their decorative side a layer representing a motif, said layer in each case comprising at least of a background and a print in the form of a motif, wherein said layer representing the motif is obtained at least by forming and dividing a larger decorative print, the method comprising: at least forming the larger print by means of one or more printing cylinders or printing rollers, wherein the print pattern of the larger print extends in the printing direction without repetitions over a distance which is larger than the circumference of the largest of said printing cylinders.

58. Method for manufacturing covered panels, comprising at least a basic panel and a top layer with a printed motif provided on this basic panel, the method comprising at least the steps of forming a decorative print on a substrate by means of at least two printing cylinders and of forming said covered panel by means of at least a portion of said substrate, wherein said decorative print comprises at least of a first print pattern and a second print pattern at least provided by means of a first and a second, respectively, of said two printing cylinders, and wherein the decorative print is formed such that it comprises at least a zone in which said first print pattern is absent, whereas said second print pattern in its turn is present in the zone concerned.

59. The method of claim 58, wherein the decorative print is formed such that it comprises at least a zone in which said second print pattern is absent, whereas said first print pattern in its turn is present in the zone concerned.

60. The method of claim 58, wherein the zones in which the first print pattern is absent, are made seamless in respect to an adjacent zone of the decorative print, in which this first print pattern in its turn is present and wherein said larger print is uninterrupted in the printing direction.

61. The method of claim 58, wherein said two printing cylinders in the printing direction are rolled off at least over a portion of their mantle surface, directly or indirectly, over the substrate and wherein the length of the respective print patterns extends in the printing direction.

62. The method of claim 58, wherein for printing the substrate, the technique of so-called rotary offset printing or intaglio printing is applied.

63. The method of claim 58, wherein for printing the substrate, a printing device is used having at least four cylinders, wherein at least one of the four cylinders effects a discontinuous print pattern on the substrate.

64. The method of claim 58, wherein the portion of the printing cylinders which is used for printing the motif of a floor panel, extends substantially transverse to the axis of this printing cylinder, such that the motif concerned, in said decorative print, extends parallel to the printing direction.

65. The method of claim 58, used for manufacturing floor panels with a length which is larger than the length of said first print pattern and/or is larger than the length of said second print pattern.
